(19) United States
(12) Patent Application Publication
(10) Pub. No.: US 2005/0082826 A1
(43) Pub. Date: Apr. 21, 2005

(54) Barb clamp

(75) Inventor: Albert A. Werth, Kewadin, MI (US)

Correspondence Address: WILLIAM M HANLON, JR;YOUNG & BASILE, PC, 3001 WEST BIG BEAVER ROAD, SUITE 624, TROY, MI, 48084-3107, US

(73) Assignee: Twin Bay Medical, Inc., Traverse City, MI (US)

(21) Appl. No.: 10/963,457

(22) Filed: Oct. 13, 2004

Related U.S. Application Data
(60) Provisional application No. 60/512,231, filed on Oct. 17, 2003.

(51) Int. Cl. F16L 27/00

(52) U.S. Cl. 285/243; 285/257

(57) ABSTRACT

A barb clamp is provided for fluid liquid or gaseous connection to a flexible tube, the flexible tube having an inner bore defined by a predetermined inner diameter for providing a fluid flow path. The barb clamp includes a barb connector having essentially the same predetermined inner diameter and a tapered end insertable into the tube. A sleeve and collet lock over the tubing and barb connector to prevent liquid material entering between the barb and tube. The tapered end of the barb connector terminates at a point so that there is essentially no transition between the inner diameter of the tube and the inner diameter of the barb connector to provide no pressure differential in the tubing between the outside and inside of the barb clamp.

This application claims priority of provisional patent application 60/512,231 filed on Oct. 17, 2003.

### FIELD OF THE INVENTION

The present invention relates to a fastening device for a tubular body.

### BACKGROUND OF THE INVENTION

The transfer of fluid through flexible tubing is widely used in various environments. Ultimately, the flexible tubing is connected to the source of the gaseous or liquid fluid, the delivery site of the fluid, or to another flexible tubing. At the ends of the flexible tubing, it is necessary to provide a secure and leak proof connections. Although these requirements are necessary in all environments using flexible tubing, it is critical in the medical and pharmaceutical, food and beverage fields. In the medical and pharmaceutical fields flexible tubing and associated connections are used for luer fittings, quick connects, or sanitary fittings such as used in blood pumps, oxygen concentrators, sleep apnea equipment, medical transport containers, IV bags, etc. In some environments, and especially in the medical field, it is imperative to absolutely prohibit any liquids from getting between the tube and the connection fitting at the connection point. Any gap or abrupt change at the point of connection will entrap fluid, e.g. bio, blood, drugs, foodstuff, etc. This entrapment can cause growth of harmful bacteria.

### SUMMARY OF THE INVENTION

The present invention addresses the aforementioned concerns. The present invention is an improved barb clamp used for joining a flexible tube to a barb fitting or connector, or straight lumen without a barb. And, in particular, for joining flexible tube to a specially constructed barb fitting that provides minuscule transition differential between the inner diameter of the tubing and the inner diameter of the barb fitting.

In one aspect of the invention the bard fitting tapers to a termination point so that there is essentially no transition between the inner diameter of the tube and the inner diameter of the bard fitting for preventing a pressure differential in the tube between a portion of the tube in the improved barb clamp and a portion of the tube outside of the barb clamp.

Other applications of the present invention will become apparent to those skilled in the art when the following description of the best mode contemplated for practicing the invention is read in conjunction with the accompanying drawings.

### BRIEF DESCRIPTION OF THE DRAWING

The description herein makes reference to the accompanying drawings wherein like reference numerals refer to like parts throughout the several views, and wherein:

FIG. 1 is a sectional view of a current barb clamp;

FIG. 2 is a partial sectional view of an alternative to the current barb clamp;

FIG. 3 is an elevational view of a collet for the current barb clamp;

FIG. 4 is a sectional view of a sleeve for the current barb clamp;

FIG. 5 is a sectional view of an improved barb clamp according to the present invention; and

FIG. 6 is a sectional view of an alternative embodiment of the improved barb clamp.

### DETAILED DESCRIPTION OF THE PREFERRED EMBODIMENT

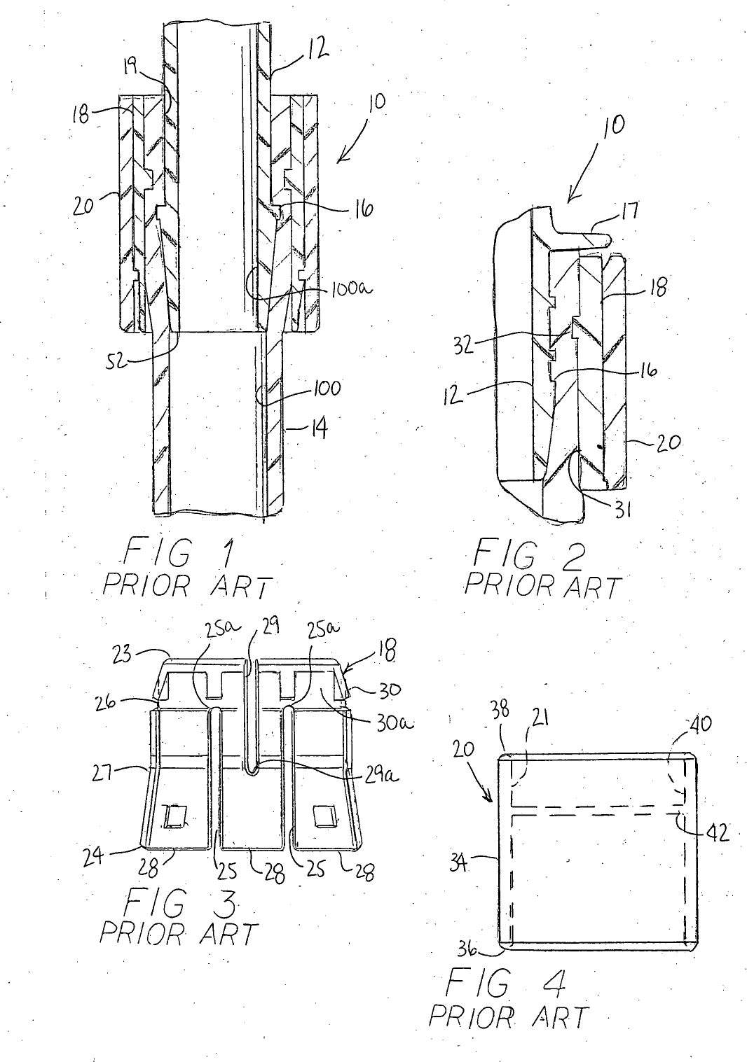

FIGS. 1 and 2 show the current barb clamp connector 10 for coupling a barbed fitting 12 and a flexible tube 14 and discussed hereafter. The barb fitting 12 is generally made of a non-metal material which allows it to be heat welded to a proprolyene or ethylene medical or pharmaceutical bag. The same and similar materials can be used for biotech, pharmaceutical, medical, and foodstuff fitting connections and manifold applications. The fitting can also be made from other plastics and stainless steel when required. As seen in FIGS. 1 and 2, the barbed fitting 12 may encompass different configurations but will generally include at least one expanded or barbed end 16 for a 360° radial compression connection to the flexible tube 14. If the barb clamp 10 is to be used in a medical or pharmaceutical environment, the barb fitting 12 is preferably made from an FDA (Food and Drug Administration) approved polypropylene, silicone, TPE, TPR, etc. The barb fitting 12 may also include a flanged portion 17 which defines a stop for the barb clamp 10.

The barb clamp 10 includes a collet 18 and a sleeve 20. The collet 18 and the sleeve 20 are as shown in FIGS. 1-6 and are similar to the collet and sleeve discussed in U.S. patent application Ser. No. 10/100,519 filed on Mar. 18, 2002, now U.S. Pat. No. 6,796,586 issued on Sep. 28, 2004.

The collet 18 is an essentially annular member having a through aperture 19 for receiving the end of a tube 14 therein. The sleeve 20 is also an annular member with a through aperture 21 for receiving the end of the tube 14 as well as having a diameter for also receiving the collet 18 therein.

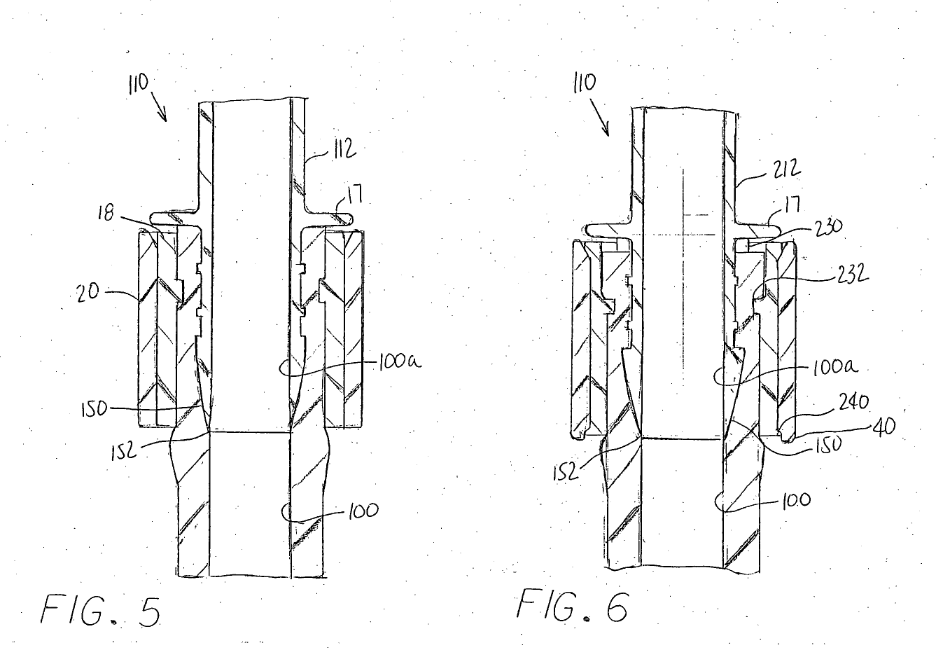

Looking at FIG. 3 the collet 18 has an exterior surface 22 providing resilient means for radially contracting around the tube 14. The collet 18 has a first end 23 forming a discontinuous annular ring. Along the exterior surface 22 and adjacent to the first end 23 is an annular groove 26. Moving toward the second end 24 and beyond the annular groove 26, the collet forms eight resilient tangs 28. The tangs 28 radially flare out or expand slightly at the second end 24 of the collet 18. The tangs 28 begin to flare approximately at the mid section 27 of each tang 28. The tangs 28 are formed by narrow through slots 25 extending from the second end 24 and terminating at the annular groove 26. The slots 25 are shown in FIGS. 3 and 5 with rounded termination ends 25a, however, the termination ends 25a may have pointed ends, (not shown).

A small ramping ledge 30 projects above each termination end 25a of the narrow through slots 25. The small ledges 30 provide added strength to the collet and also provide a stop means for the sleeve 20, as will be discussed hereinafter. Between each small ledge 30 there is a recessed planar portion 30a extending into the annular groove 26. The eight tangs 28 form a resilient seal which allow the tangs to contract around a tubular member 14. Between every other tang 28 there is a through slot 29 which extends from the first end 23 to the mid-section 27 of the associated tang 28. The through slots 29 may also have rounded termination ends 29a as shown in FIGS. 3 and 5 or pointed termination ends (not shown). The through slots 29 provide resiliency to the first end 23 of the collet 18 without sacrificing durability. The interior surface 31 of the collet 18 is essentially smooth except for a shelf 32 equally positioned on each tang 28 at the mid-section 27 for reasons to be discussed further.

Looking at FIG. 4, the sleeve 20 has a smooth exterior annular surface 34. The sleeve 20 has a first or bottom end 36 forming an arcuate base to facilitate assembly to the collet 18. The interior surface 40 forms a slight outward taper at the second or top end 38 of the sleeve 20. The interior surface 40 is essentially smooth throughout the length of the sleeve 20 except for an annular projection 42 that extends from the inner surface. The annular projection 42 is sized and positioned on the sleeve 20 for disposition within the annular groove 26 of the collet 18 to form a lock when the barb clamp 10 is engaged. Therefore, the annular projection 42 is positioned proximate to the second or top end 38 of the sleeve 20.

The sleeve 20 is first placed over the end of the tube 14 so that the second or top end 38 of the sleeve 20 is spaced furthest away from the tube end The collet 18 is then placed on the tube 14 so that the first end 23 of the collet 18 is closest to the sleeve 20. The expanded end 16 of the barbed fitting 12 is then placed into the tube 14. The expanded end 16 of the barbed fitting 12 is sized for being snugly received within the interior of the tube 14. The collet 18 is then slid over the tube 14 having the expanded end 16 of the barbed fitting 12 therein. The shelves 32 located on the interior surface 31 of the collet 18 is a retainer which forms a radial 360° compression around the tube 14 and under the expanded end 16 of the barb fitting 12 so that the barb fitting 12 cannot easily move out of the tube 14. The sleeve 20 is then slid over the collet 18 such that the first or bottom end 36 of the sleeve 20 initially encounters the first end 23 of the collet 18. As the sleeve 20 moves over the collet 18, the tangs 28 on the collet 18 are pushed radially inwardly into the tube 14 and barbed fitting 12, so that the annular shelf 32 of the collet 18 is pressed inwardly into the tube 14 and barbed fitting 12 to provide a tight seal therebetween and thereby lock the annular shelf 32 under the barb 16. The sleeve 20 continues over the collet 18 until the annular projection 42 on the interior surface 40 of the sleeve 20 sits within the annular groove 26 of the collet 18. The small ledges 30 on the exterior surface 34 of the collet 18 provides a stop and lock to prevent the annular projection 42 from moving out of annular groove 26. The barb clamp 10 “clicks” when the collet 18 and sleeve 20 lock together. The barb clamp 10 can then only be removed with the aid of a tool so that disconnection and leakages are prevented.

The improved barb clamp shown in FIGS. 5 and 6 has many of the same features as discussed with regard to FIGS. 1-4. However, the improved barb clamp 10 further includes an engineered designed barb fitting 112 which is designed to maintain the same cross sectional area of the bore or fluid passageway 100a in the barb clamp 110 as the cross-sectional area of the bore or fluid passageway 100 in the tube 14 outside of the barb clamp 10. The fluid passageway 100 outside of the barb clamp 110 is defined by the inner bore of the tube 14. The fluid passageway 100a in the improved barb clamp 110 is defined by the inner bore of the barb fitting 112, 212. As can be seen in FIGS. 1 and 2, the cross-sectional area of the fluid passageway 100 of the tube 14 is reduced within the barb clamp 10 as shown at 100a in FIG. 1. The free end 50 of the barb fitting 12 in the prior art has a blunt end 52 with a thickness that causes a transition in the cross-sectional area of the fluid passageway 100 as the tubing 14 enters the barb clamp 10 and changes to the fluid passageway 100a. One problem encountered when designing a barb connection is that it is generally necessary to have a smaller cross-sectional area of the bore in the barb fitting 12 in order to insert the barb fitting 12 into the tube 14. However, the improved clamp 10 provides a barb fitting 112, 212 that has essentially the same bore diameter as the tube 14, but can also easily be inserted into the tube 14. In the improved barb clamp 110, as shown in FIGS. 5 and 6, the barb fitting 112, 212 has an engineered bore size that has the same cross-sectional area as the bore 100 of the tubing 14. When the improved barb fitting 112, 212 is installed into a tube 14, there is virtually no transition between the inner diameter of the tubing 14 and the inner diameter of the fitting 112. As a result, there is no pressure differential on the tubing or in the fluid from outside to inside of the barb clamp 110. Maintaining a constant pressure or a constant velocity of fluid throughout the system may be imperative in certain medical applications. To accomplish this, the free end 150 of the barb fitting 112, 212 is gradually tapered to a sharp point 152. The sharp point 152 on the free end 150 of the barb fitting 112 also allows for easy insertion of the barb fitting 112 into the tube 14. As a result of this configuration, liquid material can never get between the barb fitting 112, or 212, and the tube 14.

FIG. 6 shows an alternative configuration of the barb clamp 10 which still maintains the same or equal inner diameter of the passageway of the tube 14 whether within the barb clamp or not. In FIG. 6, it is shown that the barb fitting 212 may include a bumper stop 230 which is attached to the flange 17 to act as a separate stop for the tube 14 while the flange 17 defines another stop for the collet 18, 218 and sleeve 20. The collet 218 may also be modified to have a tapered end 240 to correspond with a tapered end 40 of the sleeve. Further the annular shelf 232 of the collet 218 may be reconfigured to extend further into the tube 14 for a sturdier grip.

The collet 18 and sleeve 20 should be made of an FDA approved material if the barb clamp 10 is in a medical or pharmaceutical environment. The material should be resilient. Preferably the collet 18 is made of acetyl, silicon, or polypropylene. The sleeve 20 is preferably made of polycarbonate, silicon, or polypropylene. The components of the improved barb clamp are made of such material as polypropylene that can be sterilized in an autoclave for medical applications. Antimicrobial additives may also be added to the plastic material used in the manufacturing of at least one of the barb connector, collet, and sleeve.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A barb clamp for a flexible tube having a predetermined inner diameter, the clamp comprising:
a barb connector having a tubular configuration with a first end for disposing within an end of the tube, said barb connector having a smooth inner bore and at least one barb along an outer surface;
a collet engagable over the first end of the barb connector; and
a cylindrical sleeve having a through center aperture for receiving said collet, wherein the first end of the barb connector tapers to a termination point so that there is essentially no transition between the inner diameter of the tube and the inner diameter of the barb connector when assembled.

2. The barb clamp of claim 1, wherein the collet and sleeve have a locking ring configuration for preventing fluid material seeping between the barb connector and the tube.

3. The barb clamp of claim 1, wherein the collet has a smooth interior surface with a radial shelf extending therein for forming a radial 360° compression around the tube.

4. The barb clamp of claim 1, wherein the sleeve has an annular projection on its interior surface and the collet has an annular groove on its exterior surface for receiving the annular projection.

5. The barb clamp of claim 4, wherein the sleeve has a first end and the interior surface of the sleeve has a slight outward taper at the first end.

6. The barb clamp of claim 1, wherein the barb connector includes a flange spaced from the first end of the connector defining a stop for the tube.

7. The barb clamp of claim 6, wherein the barb connector includes a plurality of stops for the tube.

8. The barb clamp of claim 1, wherein the barb connector has essentially the same predetermined inner diameter as the flexible tube.

9. The barb clamp for a flexible tube having a flow path with predetermined inner diameter, the clamp comprising:
a barb connector insertable into one end of the tube;
a collet and sleeve engagable over the barb connector and tube for receiving the tube therein; and
means for preventing a pressure differential in the tube between a portion of the tube in the barb clamp and a portion of the tube outside of the barb clamp.

10. The back clamp of claim 8 further comprising means for preventing liquid material from getting between the tube and the barb connector.

11. The barb clamp of claim 8, wherein said barb connector, collet, and sleeve are made of a material capable of sterilization in an autoclave without damage.

12. The barb clamp of claim 8, wherein at least one of the barb connector, collet and sleeve is made of a material having antimicrobial additives.
